(19) United States
(12) Patent Application Publication
(10) Pub. No.: US 2004/0045787 A1
(43) Pub. Date: Mar. 11, 2004

(54) Coin receptacle

(76) Inventor: Thomas Zimmermann, Berlin (DE)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/396,112

(22) Filed: Mar. 25, 2003

(30) Foreign Application Priority Data
Mar. 25, 2002 (DE) DE-102 13 293.3

(51) Int. Cl. G07D 9/06; G06F 7/00; G06F 9/00; G07F 9/08; G06F 19/00

(52) U.S. Cl. 194/216; 453/61

(57) ABSTRACT

The present invention relates to a coin tray (1) having a multitude of coin slots (2) in which coin stacks (4) of individual coins (3) can be stacked up, the cross-sectional geometry of every coin slot (2) being adjusted to a certain coin denomination, wherein every coin slot (2) is provided with means (5) for detecting the number of stacked coins (3), wherein the means (5) for detecting are connected to an evaluation device (6), in which the total value of all stacked coins (3) is determined from the numbers of stacked coins (3) of all coin denominations, and as an option displayed on a display (7) and/or added up in the evaluation device (6).

### FIELD OF THE INVENTION.

The present invention relates to a coin tray having a multitude of coin slots in which coin stacks of individual coins can be stacked up, the cross-sectional geometry of every coin slot being adjusted to a certain coin denomination. The invention further relates to a cash register system comprising such a coin tray.

### BACKGROUND OF THE INVENTION AND PRIOR ART.

Conventional cash registers typically comprise a drawer with depressions, every depression being assigned to a certain coin denomination. According to the denomination, the coins are placed into the respective depressions. Firstly, it is disadvantageous herein that an operator may make a wrong assignment and thus a coin of a wrong denomination may lie in a depression. This may lead to a wrong pay-out when change money is given back. Further, it is disadvantageous that there is no electronic monitoring of the amount of cash in the cash register. In addition, it is not easily detectable, i.e. only by time-consuming counting, which coin denomination is in every depression or added-up in all depressions.

From practical cases, a coin tray of the type referred to hereinbefore is known in the art. Herein a coin unit or denomination is assigned to every coin slot being designed such that only coins having the respective denomination will fit in. A typical cross-sectional geometry is formed by a semicircular cross section. It is however also sufficient if extending in the longitudinal extension of the coin slot and distributed on a semi-circle related to the cross section of the coin slot, at least three support points are arranged. Coins having a too large diameter related to a certain coin slot will not fit into this coin slot, and are thus immediately identifiable and removable as having a wrong coin denomination. In a corresponding manner, too small coins are equally identifiable and removable due to the play occurring in the cross-sectional plane. In the coin trays known from practical cases there is for instance provided an inscription strip laterally to every coin slot, from which the total value of the coins arranged and stacked in the coin slot according to the height of the coin stack can be read. Even if in the prior art coin tray the total amounts of the coins placed in the respective coin slots can easily be read, the total amount of all coins on the coin tray must still as before be calculated from an operator. An electronic monitoring of the coin stock does not take place in this prior art device.

### TECHNICAL OBJECT OF THE INVENTION.

It is the technical object of the invention to provide a coin tray, by means of which the total stock of coin values can easily be determined by an operator without the need of calculating operations. It is furthermore the technical object of the invention to provide a coin tray, by means of which a simple and automatic determination of the contained total coin value is possible and the paid back cash can simply be monitored.

### BASICS OF THE INVENTION AND PREFERRED EMBODIMENTS

For achieving the technical object, the invention teaches a coin tray having a multitude of coin slots in which individual coin stacks can be stacked up, the cross-sectional geometry of every coin slot being adjusted to a certain coin unit, wherein every coin slot is provided with means for detecting the number of stacked coins, wherein the means for detecting are connected to an evaluation device, in which the total value of all stacked coins is determined from the numbers of stacked coins of all coin denominations, and as an option displayed and/or added-up in the evaluation device.

By means of the invention, it is achieved that without any calculating operations by an operator, the total value of all coins stocked in the coin tray is always calculated in the evaluation device and can if necessary immediately by read out. Further, the evaluation device can also monitor change pay-back processes and activate an alarm, optical and/or acoustic, in case of a faulty pay-back or unauthorized removal. Finally, the invention permits the installation of a transaction memory for the evaluation device. In a transaction memory, all operations of the coin tray, i.e. put-in of coins as well as take-out of coins, are stored, so that all pay-in and/or pay-out processes made by using the coin tray can be recorded and if necessary called-off and checked. A faulty removal or pay-out or put-in of coins not being in agreement with the result calculated by a cash register is safely detected and recorded. Further, a continuation of processes made during such a faulty operation can be blocked. As a result, no intended or unintended manipulations of the coin stock of a cash register are possible anymore.

A coin slot in the meaning of the invention is not necessarily arranged in a vertical manner. Rather, a different angle from the vertical orientation is also possible, even horizontal. In the case of a horizontal orientation of a coin slot, it has to be secured by force linkage, for instance friction, that stacked coins in the coin slot will not fall over. The term coin stack refers to a sequence of coins, beginning at one end of a coin slot. Coin surfaces stacked upon each other will touch each other with their opposite main faces, if not described differently in the following. The adjustment of the cross section of a coin slot to a coin denomination may be made in different manners. Basically, the cross section may be adjusted to the shape of the coin periphery, i.e. circular or polygonal with dimensions corresponding to the coin denomination. A coin slot related to the cross section may represent an otherwise open partial section of a circle or of a polygon, for instance an open semi-circle or quarter-circle, which is recommended in the case of rather horizontal coin slots (<70° to the horizontal axis). In the case of rather vertical coin slots (>50° or 70° to the horizontal axis), for instance a three-quarter circle may be useful. The contact of the coin peripheral surface to the coin slot may be areal or punctiform or both. In the case of a punctiform contact, at least one support element having a support face is provided on the circle or the polygon.

The means for detecting the number of stacked coins may be configured in most various ways. In one embodiment of the invention, the means for detecting are a switch element strip extending over the complete coin slot in the longitudinal direction thereof, said switch element strip comprising a multitude of switch elements, the spacing of adjacent switch elements corresponding to the height of a coin. Every switch element is operated by one coin each when put in. This operation takes place by the cylindrical surface of a coin. The number of the switch elements of a switch element strip basically corresponds to the maximum number of coins to be stacked in a coin slot. The switch conditions of all switch elements of a switch element strip can easily be evaluated in an electronic manner, thus the number of stacked coins being detected. Herefrom the total amount of all coins in a coin slot can be determined in the evaluation device. Since all coin slots are provided with a switch element strip respectively connected to the evaluation device, the total amount of all coins placed on the coin tray can be determined in an electronic manner.

Alternatively, the means for detecting may be a reflection-type light barrier strip extending over the complete coin slot referred to the longitudinal extension thereof, said light barrier strip comprising a multitude of reflection-type light barriers, the spacing of two adjacent reflection-type light barriers corresponding to the height of a coin. A reflection-type light barrier typically consists of a light transmitter and a light sensor, both being combined so to form a constructional unit. The light transmitter transmits light in the direction of a cylindrical surface of a coin brought in place. The light reflected by the cylindrical surface will strike the light sensor which thus detects a present coin. If there is no coin at the level of a reflection-type light barrier, the respective light sensor will not detect any reflected light. Thus a digital information (coin present/coin absent) corresponding to the previous embodiment is obtained.

In another alternative, the means for detecting are a photo element strip extending over the complete coin slot referred to the longitudinal extension thereof, said photo element strip comprising a multitude of photo elements, the spacing of two adjacent photo elements corresponding to the height of a coin, and a light source being arranged at the upper stack end of the coin slot. In this embodiment, all photo elements are shaded off at the level where there are coins. Compared to the above embodiments, just one light source is needed.

In another alternative embodiment, the means for detecting may be a light barrier element strip extending over the complete coin slot referred to the longitudinal extension thereof, said light barrier element strip comprising a multitude of light barrier elements, the spacing of two adjacent light barrier elements corresponding to the height of a coin, and every light barrier element referred to an axis orthogonal to the longitudinal extension of the coin slot comprising a light transmitter and a light sensor arranged opposite thereto. If the light beam directed from the light transmitter to the light sensor is interrupted by a coin in the coin slot, the light sensor will detect this.

In another embodiment of the invention, the means for detecting are an optical distance measurement device comprising a light transmitter and a light sensor, light transmitter and light sensor being arranged at the upper stack end of the coin slot and being directed toward the uppermost coin in the coin slot. The distance measurement may for instance be made according to the Doppler principle or the triangulation principle (for instance according to an example below). In both cases, a measurement and evaluation of the intensity of the reflected light may in addition take place. Further, an evaluation may also be made alone on the basis of such intensity measurements, if applicable in a wavelength-selective manner.

In the case of the Doppler principle, the uppermost coin in a coin stack is irradiated with coherent light, for instance by means of a laser diode, and reflected light is collected by means of a sensor and subjected to a phase analysis. In the case of the triangulation principle, a light source is provided, transmitting a light beam being angularly displaced relative to the longitudinal extension of the coin slot, for instance by 1 to 20 degrees. Laser light reflected by the uppermost coin is collected by a CCD sensor detecting the position of the incident light beam with a spatial resolution. From the position of incident reflected laser light, the distance of the uppermost coin can be determined. Considering the known thickness of a coin of a certain coin denomination and the geometry, in particular the length of a coin slot and the configuration of the distance measurement device, the number of coins in the coin slot can easily be calculated from the distance of the uppermost coin, and thus also the total value of stocked coins. This calculation is performed in the evaluation unit in a manner well known to the man skilled in the art. As light sources, in addition to laser diodes, light sources for incoherent light can be used, as long as a focusing to obtain a substantially parallel light beam with a limited light spot on the coin is provided.

An embodiment of the invention having an independent significance is characterized by that every coin slot comprises at least one sectioning element, by means of which a coin slot is divided into at least two sections for receiving a defined number of coins. The defined number of coins may be in the range of 5 to 200, preferably of 10 to 50, most preferably of 20 to 50. This embodiment considers that coins are subject to wear, corrosion, contamination and/or deformation in the area of their main faces and thus may have a reduced or increased thickness. This may lead to that when stacking a certain number of worn, deformed, corroded and/or contaminated coins, the assignment of the components of a strip described above will not apply anymore, since their distances are adjusted to the height of a new coin. Correspondingly, there may be a fault in an embodiment using a distance measurement device, since the calculation of the stocked coins takes place under consideration of the actually measured distance of the uppermost coin and under assumption of a proper coin height or thickness.

By a sectioning element, a coin slot is partitioned into sections, in which a small amount of coins compared to the total coin slot can be stocked. The number of coins within a section is to be selected such that wear effects or the like to be expected of the coins will not lead to a fault. According to practical experiences, tolerances may be up to 1% for hard coin materials, even 2% or more for soft coin materials. The maximum coin number in a section is selected, based on the tolerances, such that an accumulated fault of the same fault direction is less than 1 coin, better less than 0.5 coin or 0.2 coin.

It is understood that the interspaces occurring because of the sectioning device between coins of different sections are taken into account for the arrangement and configuration of the means for detecting. In the case of the embodiments with strips this means that the distance of the elements in the case of two adjacent coins of different sections is formed by the sum of the height of a coin and of the sectioning element. In the case of the embodiment with the distance measurement device, the thickness of the sectioning elements has to be taken into account in the evaluation device. This may for instance take place by that in the evaluation device the maximum number of coins for each section is stored and at arrival or counting process by the evaluation device of a number of coins in a coin slot, which is the sum of all full sections plus one coin, a reference point measurement is performed on the first coin of the new section and storage of the distance value. This distance value is used for a new start of the counting process of the respective section, thus arrangement and thickness of the sectioning elements being automatically determined and taken into account.

In the various embodiments of the invention, different variants of a safety check can be incorporated. For instance, by the embodiments using switch elements, reflection-type light barriers or light barrier elements, the detection of vacancies in a stack is possible. These vacancies can be detected and taken into account for the calculation of the total value. Further, a display of the presence of (undesired) vacancies is possible. As an addition or alternative, an alert signal may optically or acoustically be given in case of the detection of a vacancy. Further it is possible that the evaluation device is initialized with an empty coin tray and the subsequent insertion of individual coins is detected and fed to the evaluation device. The evaluation device can then always determine the actual total value, and add or subtract further inserted or removed coins from the total value and thus always add up and specify the actual total value. The initialization can of course alternatively be made with a coin tray fully equipped with coins, then in the course of removals of coins the subtractions being made starting from the maximum total value of all stacked coins.

The means for detecting may further comprise a contact, a reflection-type light barrier or a light barrier being arranged at the end, referred to the longitudinal extension of the coin slot, of a slider displaceably arranged above the open coin slot in the direction of the longitudinal direction of the coin slot, the slider being driven according to a signal of the means such that the end of the slider carrying the means is positioned in the area of the uppermost coin of a coin slot. Positioning may occur by that the end with the means leaves the uppermost coin free from the slider or just covers it. The information of the number of coins in a coin stack is then obtained as a travel information of the slider, starting from an empty coin slot. This embodiment is insofar of a special importance as that for a pay-out of change calculated by the evaluation unit for the respective coin stack, the slider can be controlled such that the calculated number of coins of the change is free ahead of the end of the slider, and can easily be taken out. Inadvertently gripping too many coins is thus safely prevented. In a kinematic variant of this embodiment, the means (5) for detecting comprise a contact, a reflection-type light barrier or a light barrier being arranged at the end, referred to the longitudinal extension of the coin slot, of a cover arranged above the open coin slot, the coin slot or the coin stack arranged therein being in the direction of the longitudinal extension of the coin slot, the coin slot or the coin stack being driven according to a signal of the means such that the end of the cover carrying the means is positioned in the area of the uppermost coin of a coin slot. The above applies in an analogous manner. Instead of travel information of the slider, travel information of the coin stack is used.

The above various means for detecting can be combined in any suitable manner in order to increase safety.

The evaluation unit may be integrated in the coin tray or provided in a cash register system connected to the coin tray. The means for detecting are electrically or optically connected to the evaluation unit. In particular in the second case, the coin tray can further be configured such that at every coin slot, an optical signal transducer is provided which marks a coin stack and will, after removal of a given number of coins from the coin stack, change its condition. Such a change of condition may be an extinguishing light signal or a color change. In this embodiment, a pay-back amount calculated by the cash register system can be converted by the cash register system and/or the evaluation unit into the corresponding numbers of coins of the respective denominations. Coin slots, from which coins have to be taken, are then marked by means of a light signal. When the calculated number of coins have been taken from a coin slot, the light signal will go out. This takes place for every calculated coin stack, until the total amount of change (coin portion) has been taken out by an operator. Thus the invention also relates to a cash register system with at least one electronic cash register and a coin tray connected to the cash register, as described above, in conjunction with the electronic cash register an evaluation device being provided by means of which the total value of all stacked coins in the coin tray can be determined, and by means of which a coin change amount can be displayed in the above manner. Insofar, the invention also relates to a method for operating a coin tray according to the invention having the methodical features described above.

In the following, the invention will be described in more detail, with reference to figures merely representing examples of execution. There are:

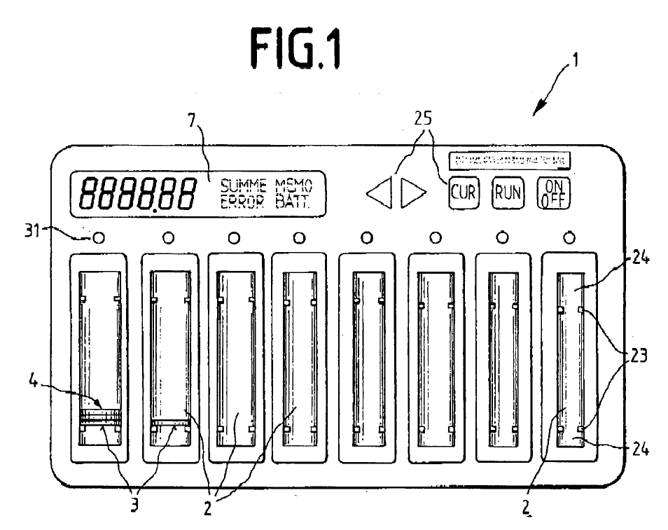

FIG. 1 a survey diagram of a coin tray according to the invention,

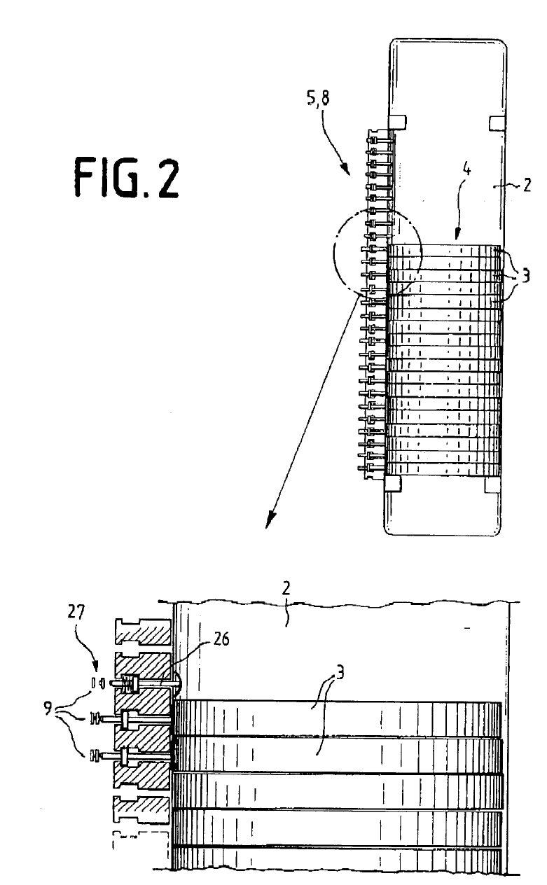

FIG. 2 an embodiment having contacts as means for detecting,

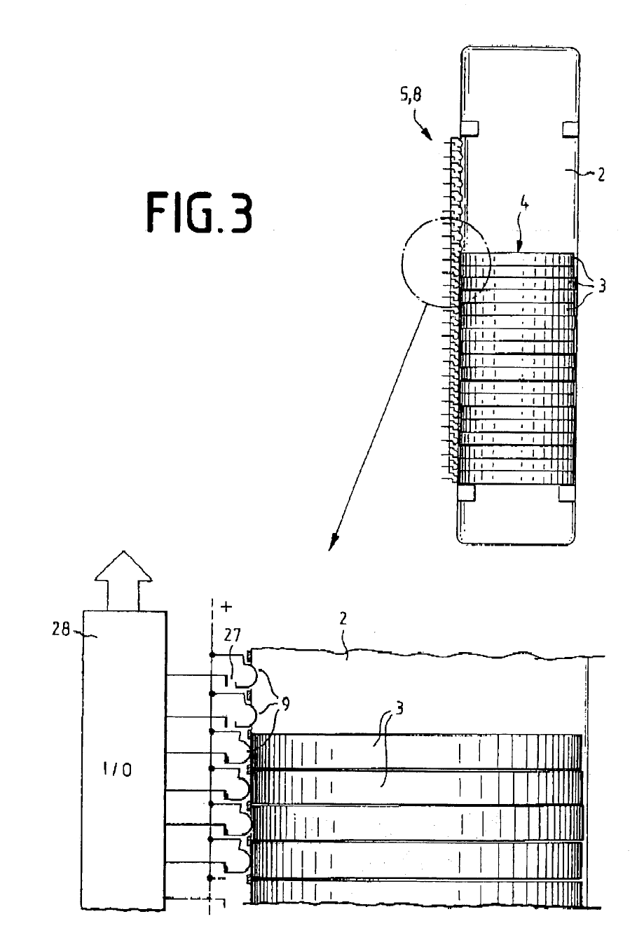

FIG. 3 a variant of the subject matter of FIG. 2,

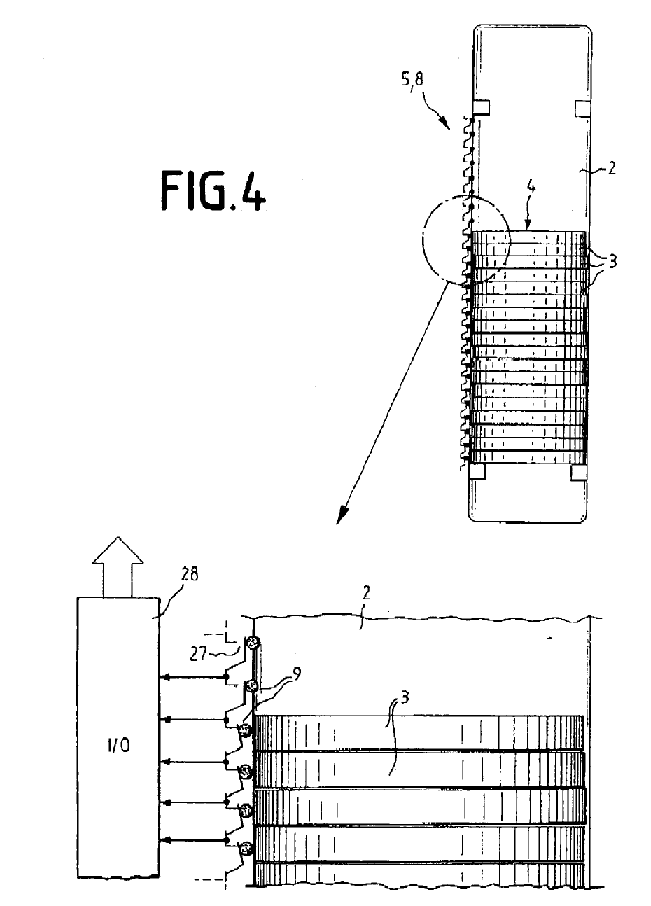

FIG. 4 another variant of the subject matter of FIG. 2,

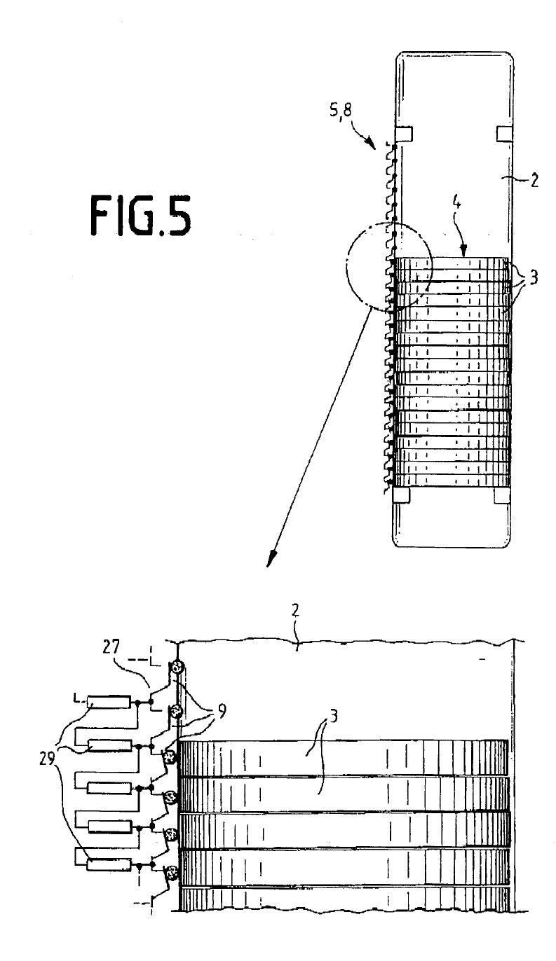

FIG. 5 still another variant of the subject matter of FIG. 2,

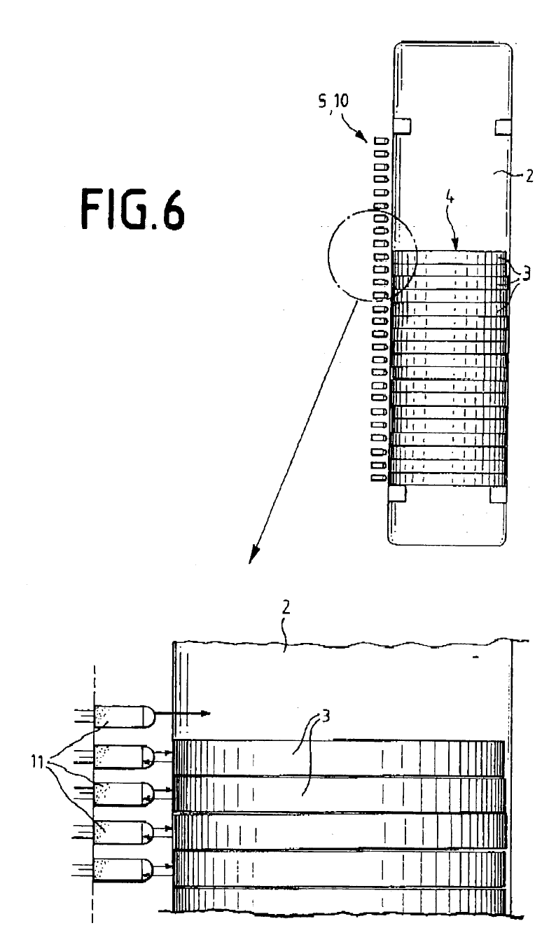

FIG. 6 an embodiment having reflection-type light barriers as means for detecting,

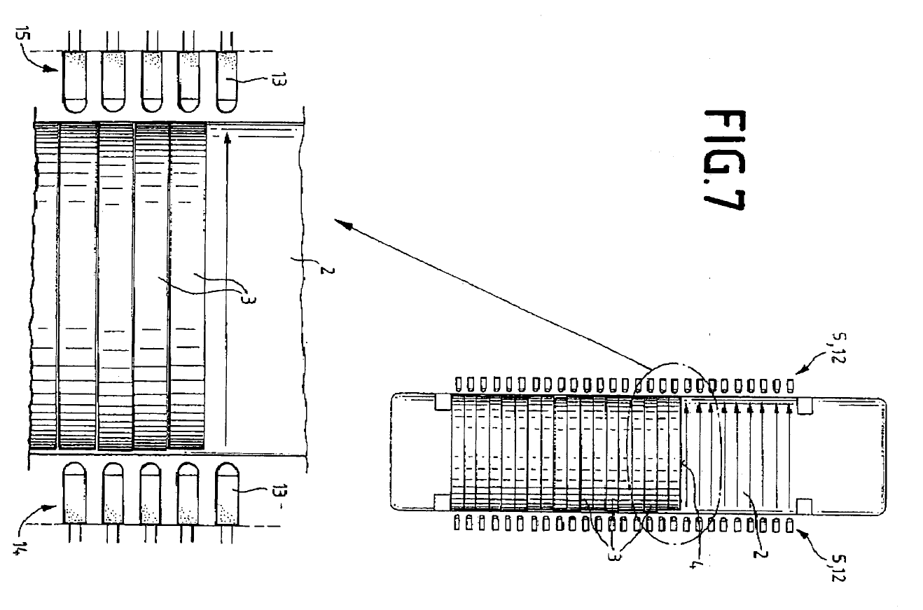

FIG. 7 an embodiment having light barrier elements as means for detecting,

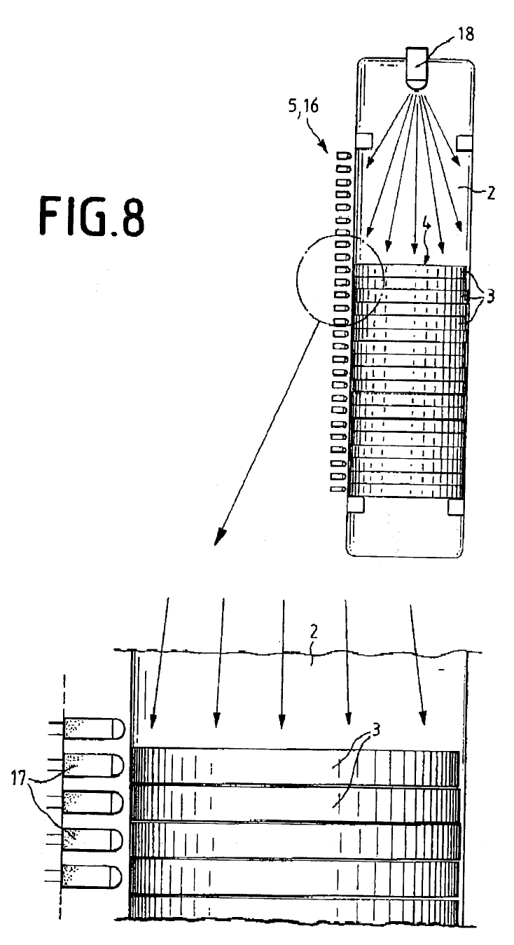

FIG. 8 an embodiment having photoelements and only one light source as means for detecting,

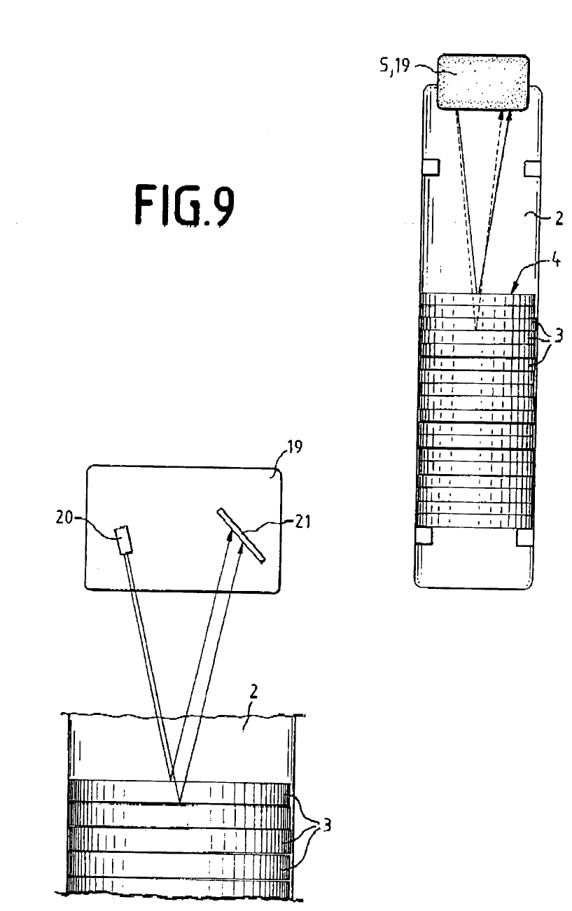

FIG. 9 an embodiment having a distance sensor as means for detecting,

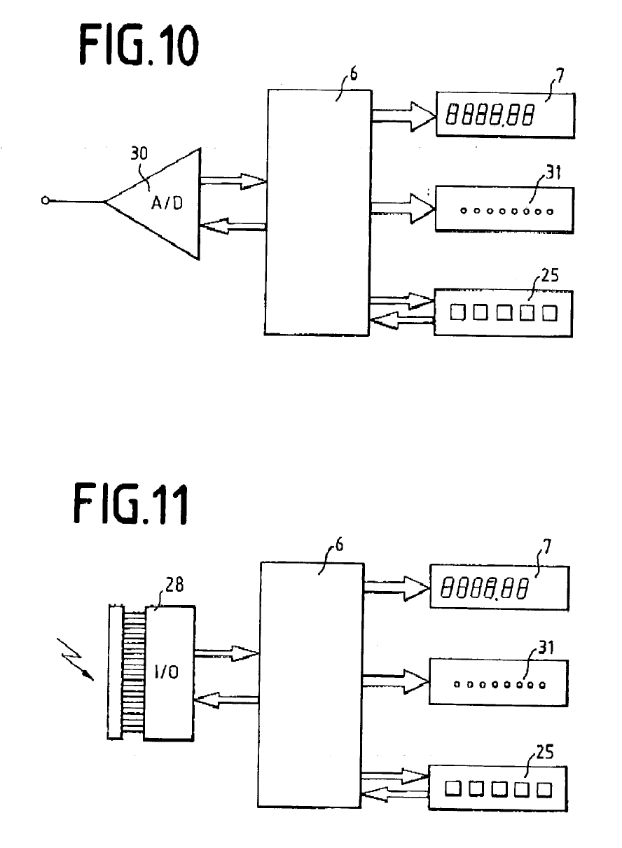

FIG. 10 a block diagram with analog detection by the means for detecting,

FIG. 11 a block diagram with digital detection by the means for detecting, and

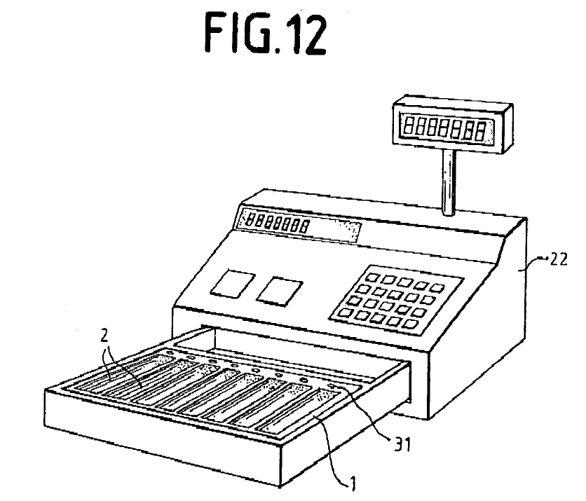

FIG. 12 a cash register system according to the invention.

Referring now to FIG. 1, there is a coin tray 1 according to the invention shown having a multitude of coin slots 2 in which coin stacks 4 of individual coins 3 can be stacked up, the cross-sectional geometry of every coin slot 2 being adjusted to a certain coin denomination. In the embodiment, the coin slots are limited by end elements 23. Upon the coin slots 2 follow gripping depressions 24 permitting a removal of coins 3 from a filled-up coin slot 2. A display 7 can be seen, on which for instance the sum of all stocked coins 3 can be read. Further, an operating field 25 having keys for controlling the evaluation device 6 is provided.

From FIGS. 2 to 9 can be taken that every coin slot 2 is provided with means for detecting the number of stacked coins 3, the means 5 for detecting being connected to an evaluation device 6 in which the total value of all stacked coins 3 is determined from the numbers of stacked coins 3 of all coin denominations, and as an option displayed on a display 7 and/or added-up in the evaluation device 6.

According to FIGS. 2 to 5, the means 5 for detecting are a switch element strip 8 extending over the complete coin slot 2 in the longitudinal direction thereof, said switch element strip 8 comprising a multitude of switch elements 9, the spacing of adjacent switch elements 9 corresponding to the height of a coin 3. In FIG. 2 can be seen spring-loaded contact pins 26, by means of which during the introduction of a coin 3 and against the spring pressure a pair of contacts 27 is closed. FIG. 3 shows a variant in which the pairs of contacts 27 are connected in a parallel manner to a port or a shift register 28 of the evaluation device 6. FIG. 4 shows on the other hand a series connection of the pairs of contacts 27 with connection to a port or a shift register 28. In FIG. 5 is represented a wiring scheme of the pairs of contacts 27 in a resistor network 29. When a voltage is applied via an additional resistor to the resistor network 29, a voltage is obtained at the resistor network 29 which is a function (linear with identical resistance values of the resistors) of the number of closed pairs of contacts 27. This voltage is converted by means of an analog to digital converter 30 into a digital signal and fed to the evaluation device 6.

FIG. 6 shows an embodiment, wherein the means 5 for detecting are a reflection-type light barrier strip 10 extending over the complete coin slot 2 referred to the longitudinal extension thereof, said reflection-type light barrier strip 10 comprising a multitude of reflection-type light barriers 11, the spacing of two adjacent reflection-type light barriers 11 corresponding to the height of a coin 3.

In FIG. 7, the means 5 for detecting are a light barrier element strip 12 extending over the complete coin slot 2 referred to the longitudinal extension thereof, said light barrier element strip 12 comprising a multitude of light barrier elements 13, the spacing of two adjacent light barrier elements 13 corresponding to the height of a coin 3, and every light barrier element 13 referred to an axis orthogonal to the longitudinal extension of the coin slot 2 comprising a light transmitter 14 and a light sensor 15 arranged opposite thereto.

In FIG. 8, the means 5 for detecting are a photo element strip 16 extending over the complete coin slot 2 referred to the longitudinal extension thereof, said photo element strip 16 comprising a multitude of photo elements 17, the spacing of two adjacent photo elements 17 corresponding to the height of a coin 3, and a light source 18 being arranged at the upper stack end of the coin slot 2, the light of which will strike photo elements 17 not shaded off by coins 3.

In the embodiments of FIGS. 6 to 8, the light sensors or photo elements are connected to the evaluation device 6 for instance according to FIG. 3.

In FIG. 9 is shown an embodiment, wherein the means 5 for detecting are an optical distance measurement device 19 comprising a light transmitter 20 and a light sensor 21, light transmitter 20 and light sensor 21 being arranged at the upper stack end of the coin slot 2 and being directed toward the uppermost coin 3 in the coin slot 2. The light transmitter 20 is a laser diode with a narrow light beam striking the coin main surface at an angle different from the orthogonal axis. The reflected light beam will, with different heights of the coin stack 4, strike different positions of the light sensor 21 configured as a CCD sensor suitable for a spatial resolution. This position information is converted into a distance information, and this in turn into a value information corresponding to the thus determined height of the coin stack 4.

FIG. 10 shows a block diagram suitable for an embodiment according to FIG. 5 with a resistor network. FIG. 11 shows a suitable block diagram for the subject matters of FIGS. 3, 4, 6, 7 and 8.

FIG. 12 shows a cash register system comprising at least one cash register 22 and a coin tray 11 according to the invention connected to the cash register 22, said coin tray being suitable for a drawer of the cash register and being connected to the evaluation device 6 of the cash register. By means of the evaluation device 6, for instance the total value of all stacked coins 3 in the coin tray 1 can be determined. A pay-back amount calculated by the cash register 22 is converted by the evaluation device 6 into the respective numbers of coins to be paid back. A select display 31 is activated for the coins to be paid back and remains activated until the number of coins 3 determined by the evaluation device 6 have been removed. The cash register 22 may in addition comprise lamp displays for “overpaid” and/or “pay-back amount OK”. Several cash registers 22 can be connected to each other and to a master evaluation device, and then the total coin stock of a complete shop can always be added up. It is also possible that the evaluation device 6 detects and displays a re-fill requirement for a certain coin denomination if it is below a defined minimum number of coins 3 of a certain denomination, or transmits this to the master evaluation device.

Not shown in the drawings are the following variants according to the invention. For instance, a scanner strip or a contact image sensor may be arranged along the longitudinal extension of the coin slot. Several scanner strips may also be used. It is also possible that the scanner strip is moved in a direction orthogonal to the longitudinal extension of the scanner strip. Scanner strips and the respective electronic circuitries for controlling and image detecting are known from the conventional scanner devices for scanning pictures, texts etc. In this variant, so to speak a single-line (a fixed scanner strip) or multi-line (a scanning scanner strip or a multitude of scanner strips) image of the coins present in the coin slot is taken. This image can be evaluated with regard to the number of shown coin denominations, any structures (in particular thickness and/or edge embossing, the latter with a multi-line image), and color, usual algorithms being suitable for this. It is however in addition possible to make a test for the coin type, and in the case that a coin of wrong denomination or a counterfeit coin is in the coin slot, to generate a corresponding signal.

Further not shown is a variant of the invention using an eddy-current sensor. Such sensors are per se known in the art, for instance from the sensors for detecting the expansion or contraction of metallic components. They basically consist of two parallely or anti-parallely extending induction elements, for instance printed coils connected by a bridge circuit. The generated signal is a measure for the length of the “coin stack” in the coin slot and thus for the number of the coins present therein.

1. A coin tray (1) having a multitude of coin slots (2) in which coin stacks (4) of individual coins (3) can be stacked up, the cross-sectional geometry of every coin slot (2) being adjusted to a certain coin denomination, wherein every coin slot (2) is provided with means (5) for detecting the number of stacked coins (3), wherein the means (5) for detecting are connected to an evaluation device (6), in which the total value of all stacked coins (3) is determined from the numbers of stacked coins (3) of all coin denominations, and as an option displayed on a display (7) and/or added-up in the evaluation device (6).

2. A coin tray (1) according to claim 1, wherein every coin slot (2) comprises at least one sectioning element, by means of which a coin slot (2) is divided into at least two sections of receiving a defined number of coins (3).

3. A coin tray (1) according to claims 1 or 2, wherein the defined number of coins is in the range of 5 to 200, preferably of 10 to 50, most preferably of 20 to 50.

4. A coin tray (1) according to one of claims 1 to 3, wherein the means (5) for detecting are a switch element strip (8) extending over the complete coin slot (2) in the longitudinal direction thereof, said switch element strip (8) comprising a multitude of switch elements (9), the spacing of adjacent switch elements (9) corresponding to the height of a coin (3).

5. A coin tray (1) according to one of claims 1 to 3, wherein the means (5) for detecting are a reflection-type light barrier strip (10) extending over the complete coin slot (2) referred to the longitudinal extension thereof, said reflection-type light barrier strip (10) comprising a multitude of reflection-type light barriers (11), the spacing of two adjacent reflection-type light barriers (11) corresponding to the height of a coin (3).

6. A coin tray (1) according to one of claims 1 to 3, wherein the means (5) for detecting are a light barrier element strip (12) extending over the complete coin slot (2) referred to the longitudinal extension thereof, said light barrier element strip (12) comprising a multitude of light barrier elements (13), the spacing of two adjacent light barrier elements (13) corresponding to the height of a coin (3), and every light barrier element (13) referred to an axis orthogonal to the longitudinal extension of the coin slot (2) comprising a light transmitter (14) and a light sensor (15) arranged opposite thereto.

7. A coin tray (1) according to one of claims 1 to 3, wherein the means (5) for detecting are a photo element strip (16) extending over the complete coin slot (2) referred to the longitudinal extension thereof, said photo element strip (16) comprising a multitude of photo elements (17), the spacing of two adjacent photo elements (17) corresponding to the height of a coin (3), and a light source (18) being arranged at the upper stack end of the coin slot (2), the light of which will strike photo elements (17) not shaded off by coins (3).

8. A coin tray (1) according to one of claims 1 to 3, wherein the means (5) for detecting are an optical distance measurement device (19) comprising a light transmitter (20) and a light sensor (21), light transmitter (20) and light sensor (21) being arranged at the upper stack end of the coin slot (2) and being directed toward the uppermost coin (3) in the coin slot (2).

9. A coin tray (1) according to one of claims 1 to 3, wherein the means (5) for detecting comprise a contact, a reflection-type light barrier or a light barrier being arranged at the end, referred to the longitudinal extension of the coin slot, of a slider displaceably arranged above the open coin slot in the direction of the longitudinal direction of the coin slot, the slider being driven according to a signal of the means such that the end of the slider carrying the means is positioned in the area of the uppermost coin of a coin slot.

10. A coin tray (1) according to one of claims 1 to 3, wherein the means (5) for detecting comprise a contact, a reflection-type light barrier or a light barrier being arranged at the end, referred to the longitudinal extension of the coin slot, of a cover arranged above the open coin slot, the coin slot or the coin stack arranged therein being disposed in the direction of the longitudinal extension of the coin slot, the coin slot or the coin stack being driven according to a signal of the means such that the end of the cover carrying the means is positioned in the area of the uppermost coin of a coin slot.

11. A coin tray (1) according to one of claims 1 to 10, wherein the evaluation unit (6) is integrated in the coin tray (1) or provided in a cash register system (22) connected to the coin tray (1).

12. A coin tray (1) according to one of claims 1 to 3, wherein the means (5) for detecting are a scanner strip or a contact image sensor extending over the complete coin slot (2) referred to the longitudinal extension thereof.

13. A coin tray (1) according to one of claims 1 to 3, wherein the means (5) for detecting are an eddy-current sensor extending over the complete coin slot (2) referred to the longitudinal extension thereof.

14. A cash register system with at least one electronic cash register (22) and a coin tray (1) connected to the cash register (22) according to one of claims 1 to 13, wherein an evaluation device (6) is provided by means of which the total value of all stacked coins (3) in the coin tray (1) can be determined, and by means of which as an option a coin change amount can be displayed on the coin tray (1).
